(19) United States
(12) Patent Application Publication
(10) Pub. No.: US 2011/0273274 A1
(43) Pub. Date: Nov. 10, 2011

(54) TRANSCEIVER WHICH REMOVES PHASE NOISE

(75) Inventors: Sung-chan JUNG, Changwon-city (KR); Su-kyum KIM, Changwon-city (KR); Youngoo YANG, Suwon-city (KR)

(73) Assignees: SUNGKYUNKWAN UNIVERSITY FOUNDATION FOR CORPORATE COLLABORATION, Suwon-city (KR); SAMSUNG TECHWIN CO., LTD., Changwon-city (KR)

(21) Appl. No.: 13/102,225

(22) Filed: May 6, 2011

(30) Foreign Application Priority Data
May 10, 2010 (KR) 10-2010-0043609

(51) Int. Cl. H04Q 5/22; H04B 1/40

(52) U.S. Cl. 340/10.1; 455/84

(57) ABSTRACT

A transceiver is provided. The transceiver includes a transmission portion which generates a transmission signal; an antenna which transmits the transmission signal and receives a reception signal; a signal division element which receives the transmission signal from the transmission portion and inputs the received transmission signal to the antenna for transmission, and receives the reception signal received by the antenna; an extraction signal adjusting portion which extracts the transmission signal from the signal division element, and adjusts a phase of the extracted signal to generate an output signal; and a receiving portion which receives the reception signal from the signal division element, and applies the output signal from the extraction signal adjusting portion to the reception signal.

### CROSS-REFERENCE TO RELATED PATENT APPLICATION

This application claims priority from Korean Patent Application No. 10-2010-0043609, filed on May 10, 2010, the disclosure of which is incorporated herein in its entirety by reference.

### BACKGROUND

1. Field

Apparatuses consistent with exemplary embodiments relate to a transceiver, and more particularly to, a transceiver for transmitting operating power to an object transceiver such as a radio frequency identification (RFID) tag in a receiving mode.

2. Description of the Related Art

FIG. 1 illustrates an RFID system as a related art transceiving system. Such a related art RFID reader system is disclosed in U.S. Pat. No. 7,407,110.

Referring to FIG. 1, in the RFID system as a related art transceiving system, each of RFID readers as transceivers 111a through 111m receives tag information from each of RFID tags as object transceivers 121a through 121n and 191a through 191n, and transmits the received tag information to a host device 32 over a communication network 31.

Each of the transceivers 111a through 111m must use a spurious wave removing filter for removing a spurious wave of a transmission signal from a transmitting unit according to a spurious wave specification so as to minimize an influence on an adjacent channel. Thus, the spurious wave removing filter has a very narrow transmission frequency band.

FIG. 2 is a graph illustrating a characteristic of the spurious wave removing filter of a related art transceiver such as an RFID reader. The characteristic is that of a surface acoustic wave (SAW) filter that is well known as a spurious wave removing filter. A reference numeral 21 denotes a curve of a characteristic of a phase with respect to frequencies. A reference numeral 22 denotes a curve of a characteristic of a signal loss with respect to frequencies.

Referring to FIG. 2, the signal loss rapidly varies with respect to frequencies. In particular, the phase very rapidly varies with respect to frequencies. In this regard, such rapid variations of the phase mean a rapid increase in a delay time. Also, the increase in a delay time means a change of a phase noise component.

An oscillation signal generated from an oscillation unit also has a phase noise component. The oscillation signal leaks from a signal division element or is reflected from a transmission and reception antenna, and is received along with a reception signal. Thus, if a leak component of the oscillation signal including a changed phase noise component is down-converted, the reception signal has a very large phase noise.

For example, if a transmission frequency band is between 950 MHz and 952 MHz, the delay time extracted by applying measured data to a calculation equation is about 300 nS. Such a delay time is very long compared to the overall delay time of all devices, except for the spurious wave removing filter, and response delay time between tags and readers. Further, as is well known, each of the RFID readers as transceivers 111a through 111m transmits a tag power signal to each of the RFID tags as object transceivers 121a through 121n and 191a through 191n in a receiving mode. The tag power signal partially leaks from the signal division element or is reflected from the transmission and reception antenna and is received along with the reception signal.

Therefore, the reception signal that is down-converted to the base frequency band includes phase noise and leakage and reflection signals, which deteriorates receiving performance of each of the transceivers 111a through 111m.

In conclusion, an increase in the delay time due to the spurious wave removing filter causes a phase noise component in the down-converted reception signal, which reduces a recognizable distance or anti-collision performance.

### SUMMARY

One or more exemplary embodiments provide a transceiver that may effectively remove a phase noise component remaining in a down-converted reception signal, thereby increasing a recognizable distance or improving anti-collision performance.

According to an aspect of an exemplary embodiment, there is provided a transceiver including an oscillation portion, a transmission portion, a spurious wave removing filter, a transmission and reception antenna, a signal division element, an extraction signal adjusting portion, and a receiving portion.

The oscillation portion may generate an oscillation signal.

The transmission portion may convert a transmission signal of a base frequency band into a transmission signal of a radio frequency band by using the oscillation signal generated by the oscillation portion.

The spurious wave removing filter may remove a spurious wave of the transmission signal converted by the transmission portion.

The signal division element may apply the transmission signal of the radio frequency band, which is processed by the spurious wave removing filter to the transmission and reception antenna, and receives a reception signal of the radio frequency band from the transmission and reception antenna.

The extraction signal adjusting portion may extract the transmission signal from the signal division element and adjust a phase of the extracted signal to generate an output signal.

The receiving portion may convert the reception signal received at the signal division element into a reception signal of the base frequency band by using the output signal from the extraction signal adjusting portion.

According to the transceiver of the present exemplary embodiment, a long delay time of the spurious wave removing filter causes a change of the phase noise component in the oscillation signal generated from the oscillation unit.

However, while the receiving portion converts the reception signal of the radio frequency band into the reception signal of the base frequency band, the output signal adjusted by the extraction signal adjusting portion is combined with the reception signal of the radio frequency band, and thus, the phase noise component may be removed from the reception signal of the radio frequency band.

That is because the output signal adjusted by the extraction signal adjusting portion is the transmission signal extracted from the signal division element so that the phase noise component of the output signal overlaps that of the reception signal of the radio frequency band.

However, when the transmission signal extracted from the signal division element is merely used for down-conversion of a frequency, a direct current (DC) noise occurs in the reception signal of the base frequency band. Such a DC noise component has a uniform frequency band like the phase noise component, which influences the reception signal down-converted to the base frequency band.

Thus, the extraction signal adjusting portion extracts the transmission signal from the signal division element, and adjusts a phase of the extracted signal, thereby preventing the phase noise from being influenced and the DC noise from occurring.

In conclusion, according to the transceiver of the present exemplary embodiment, a phase noise component may be effectively removed from a reception signal, thereby increasing a recognizable distance and improving anti-collision performance.

### BRIEF DESCRIPTION OF THE DRAWINGS

The above and other aspects will become more apparent by describing in detail exemplary embodiments thereof with reference to the attached drawings, in which:

FIG. 1 illustrates a radio frequency identification (RFID) system including RFID readers as related art transceivers that each receives tag information from a plurality of RFID tags and transmits the tag information to a host device;

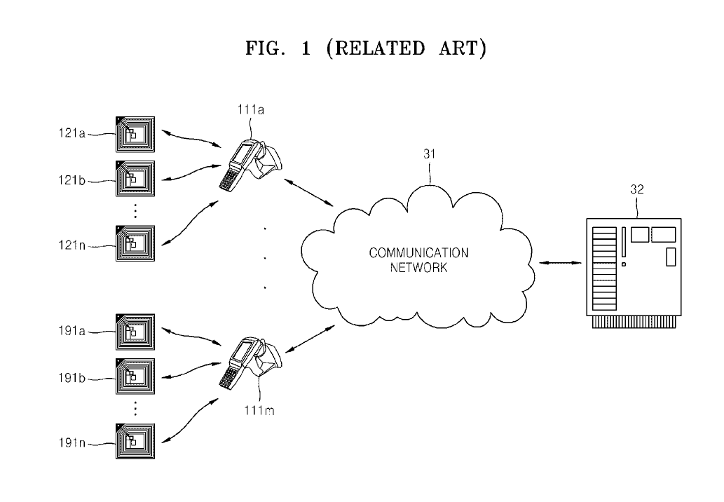

FIG. 2 is a graph illustrating a characteristic of a spurious wave removing filter of the RFID reader as a related art transceiver;

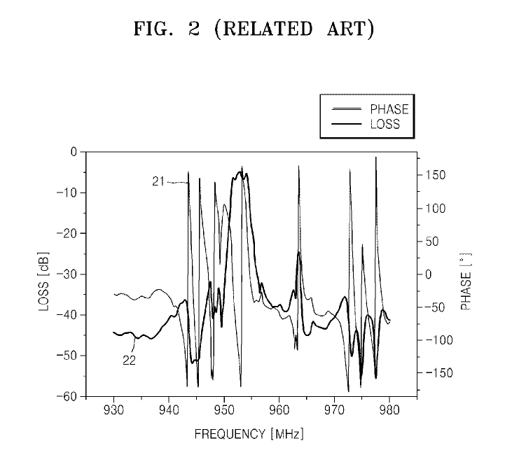

FIG. 3 is a block diagram of an RFID reader as a transceiver according to an exemplary embodiment;

FIG. 4 is a block diagram of an RFID reader as a transceiver according to another exemplary embodiment; and

FIG. 5 is a block diagram of an RFID reader as a transceiver according to yet another exemplary embodiment.

### DETAILED DESCRIPTION OF EXEMPLARY EMBODIMENTS

Hereinafter, the exemplary embodiments will be described more fully with reference to the accompanying drawings. The detailed description and the drawings are introduced to provide an understanding of the inventive concept and the detailed descriptions of well-known technologies may be omitted. In addition, the specification and the drawing are not provided to limit the scope of the inventive concept and the scope of the inventive concept is defined by the claims. The terminologies used herein are for the purpose of describing exemplary embodiments, and thus, may be interpreted to correspond to the meaning and concept of the inventive concept.

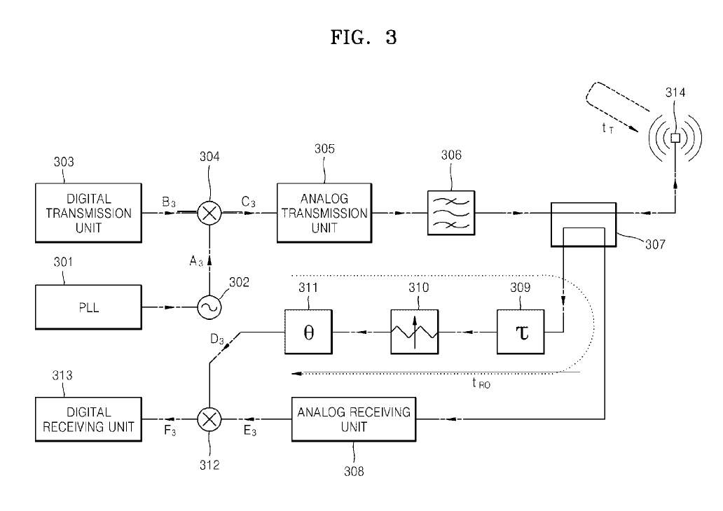

FIG. 3 is a block diagram of a radio frequency identification (RFID) reader as a transceiver according to an exemplary embodiment.

Referring to FIG. 3, the transceiver of the present exemplary embodiment includes an oscillation portion 301 and 302, a transmission portion 303 through 305, a spurious wave removing filter 306, a transmission and reception antenna 314, a signal division element 307, an extraction signal adjusting portion 309 through 311, and a receiving portion 308, 312, and 313.

The oscillation portion 301 and 302 generates an oscillation signal A₃.

The transmission portion 303 through 305 converts a transmission signal B₃ of a base frequency band into a transmission signal C₃ of a radio frequency band.

The spurious wave removing filter 306 may remove a spurious wave from the transmission signal C₃ of the radio frequency band.

The signal division element 307 applies a transmission signal of the radio frequency band, which is processed by the spurious wave removing filter 306 to the transmission and reception antenna 314, and receives a reception signal of a radio frequency band from the transmission and reception antenna 314.

The extraction signal adjusting portion 309 through 311 extracts the transmission signal from the signal division element 307, and adjusts a phase of the extracted signal. Further, the extraction signal adjusting portion 309 through 311 adjusts a size and a delay time of the extracted signal.

The receiving portion 308, 312, and 313 converts a reception signal received by the signal division element 307 into a reception signal F₃ of a base frequency band by using an output signal D₃ adjusted by the extraction signal adjusting portion 309 through 311.

According to the RFID reader as a transceiver of the present exemplary embodiment, a long delay time of the spurious wave removing filter 306 causes a change of a phase noise component in the oscillation signal A₃ generated from the oscillation unit 301 and 302.

However, while the receiving portion 308, 312, and 313 converts the reception signal into the reception signal F₃ of the base frequency band, the output signal D₃ adjusted by the extraction signal adjusting portion 309 through 311 is combined with a reception signal E₃, and thus, the phase noise component may be removed from the reception signal.

That is, because the output signal D₃ adjusted by the extraction signal adjusting portion 309 through 311 is the transmission signal extracted from the signal division element 307, the phase noise component of the output signal D₃ overlaps that of the reception signal E₃.

However, when the transmission signal extracted from the signal division element 307 is merely used for down-conversion of a frequency, a direct current (DC) noise occurs in the reception signal F₃ of the base frequency band. Thus, it may be possible to prevent the DC noise from occurring by adjusting the phase of an extracted signal in the extraction signal adjusting portion 309 through 311.

In conclusion, according to the RFID reader as a transceiver of the present exemplary embodiment, a phase noise component may be effectively removed from a reception signal, thereby increasing a recognizable distance and improving anti-collision performance.

The RFID reader as a transceiver of the present exemplary embodiment will now be described in more detail.

The oscillation portion 301 and 302 is respectively a phase locked loop (PLL) circuit 301 and a signal generating unit 302. The signal generating unit 302 generates an oscillation signal A₃ of a set frequency. The PLL circuit 301 is connected to the signal generating unit 302 and fixes a frequency of the oscillation signal A₃.

If an amplitude of the oscillation signal A₃ is not considered, the oscillation signal A₃ may be defined according to equation 1 below,

A₃=cos [ω_{C}t+Φ(t)], [Equation 1]

where ω_{C} denotes an oscillation angular frequency, and Φ(t) denotes a phase noise component of the oscillation portion 301 and 302.

The transmission portion 303 through 305 is respectively a digital transmission unit 303, an up mixer 304, and an analog transmission unit 305.

The digital transmission unit 303 encodes transmission data, converts the encoded transmission data into an analog signal, and generates a transmission signal B₃ of a base frequency band.

The transmission signal B₃ of the base frequency band has a DC voltage in a receiving mode. Thus, if an amplitude of the transmission signal B₃ is not considered, the transmission signal B₃ of the base frequency band may be defined according to equation 2 below.

B₃=cos 0°=1 [Equation 2]

The up mixer 304 converts the transmission signal B₃ of the base frequency band into the transmission signal C₃ of the radio frequency band by using the oscillation signal A₃ generated by the oscillation portion 301 and 302.

Thus, if an amplitude of the transmission signal C₃ is not considered, since the transmission signal C₃ of the radio frequency band is obtained by multiplying a function of the transmission signal B₃ of the base frequency band and a function of the oscillation signal A₃, the transmission signal C₃ of the radio frequency band may be defined according to equation 3 below.

B₃=cos [ω_{C}t+Φ(t)], [Equation 3]

where ω_{C} denotes an oscillation angular frequency, and Φ(t) denotes the phase noise component of the oscillation portion 301 and 302.

The analog transmission unit 305 amplifies the transmission signal C₃ converted by the up mixer 304, and inputs the amplified transmission signal C₃ into the spurious wave removing filter 306.

A surface acoustic wave (SAW) filter may be used as the spurious wave removing filter 306.

A directional combiner, a Wilkinson power divider, an unequal Wilkinson power divider, a rat-race power divider, and the like may be used as the signal division element 307.

The extraction signal adjusting portion 309 through 311 is respectively a delay unit 309, an attenuation unit 310, and a phase adjusting unit 311 for performing a main function. The locations of the phase adjusting unit 311, the delay unit 309, and the attenuation unit 310 as shown in FIG. 3 may be switched.

The delay unit 309 delays a signal extracted from the signal division element 307 by a set period of time, and inputs the delayed signal into the attenuation unit 310 to remove the phase noise.

A distribution element, such as a microstrip line structure, a strip line structure, and a coaxial cable, or a filter, an inductor, and a capacitor may be used as the delay unit 309. In this regard, a lumped element or a distribution element, or an electrically adjustable element, such as a varactor diode and a transistor, may be used as the capacitor. Likewise, the lumped element or the distribution element may be used as the inductor.

The attenuation unit 310 reduces an amplitude of the extracted signal for an operation of a rear end.

When the attenuation unit 310 is manufactured as a fixing attenuation unit, a lumped element or a distribution element may be used as the fixing attenuation unit. When the attenuation unit 310 is manufactured as a variable attenuation unit, an electrically adjustable element, such as a PIN diode, the lumped element, or the distribution element may be used as the variable attenuation unit.

The phase adjusting unit 311 adjusts a phase of the extracted signal processed by the attenuation unit 310 to generate the output signal D₃.

When the phase adjusting unit 311 is manufactured as a fixing phase adjusting unit, a lumped element or a distribution element may be used as the fixing phase adjusting unit. When the phase adjusting unit 311 is manufactured as a variable phase adjusting unit, an electrically adjustable element, such as a varactor diode, the lumped element, or the distribution element may be used as the variable phase adjusting unit.

If an amplitude of the output signal D₃ is not considered, the output signal D₃ of the phase adjusting unit 311 may be defined according to equation 4 below,

D₃=cos [ω_{C}(t−t_{RO})+Φ(t−t_{RO})+θ], [Equation 4]

where θ denotes a phase adjusted by the phase adjusting unit 311, t_{R0} denotes a total delay time of the output signal D₃, and ω_{C} denotes an oscillation angular frequency.

The receiving portion 308, 312, and 313 is respectively an analog receiving unit 308, a down mixer 312, and a digital receiving unit 313.

The analog receiving unit 308 amplifies the reception signal received from the signal division element 307, and may remove a harmonic wave component from the amplified signal to generate the reception signal E₃.

If an amplitude of the reception signal E₃ is not considered, the reception signal E₃ processed by the analog receiving unit 308 may be defined according to equation 5 below,

E₃=cos [ω_{C}(t−t_{RO})+Φ(t−t_{RO})]+cos [(ω_{C}+ωₘ)(t−t_{RO}−t_{T})+Φ(t−t_{RO}−t_{T})], [Equation 5]

where ω_{C} denotes an angular oscillation frequency, t_{R0} denotes a delay time of the RFID reader mainly caused by a spurious wave removing filter, ωₘ denotes an angular frequency of a base frequency band included in a reception signal from a tag, and t_{T} denotes a response delay time in proportion to a distance between the tag and the RFID reader.

Thus, Φ(t−t_{RO}) denotes a phase noise component caused by a delay of the extracted signal, and Φ(t−t_{RO}−t_{T}) denotes a phase noise component caused by a delay of the reception signal applied to the down mixer 312.

The down mixer 312 converts the reception signal E₃ of the analog receiving unit 308 into the reception signal F₃ of the base frequency band by using the output signal D₃ of the phase adjusting unit 311.

Thus, if the phase θ adjusted by the phase adjusting unit 311 is 90° without considering an amplitude of the reception signal F₃, since the reception signal F₃ of the base frequency band is obtained by multiplying a function of the output signal D₃ adjusted by the extraction signal adjusting portion 309 through 311 and a function of the reception signal E₃ of the analog receiving unit 308, the reception signal F₃ may be defined according to equation 6 below.

F₃=cos [ωₘ(t−t_{RO})+ω_{C}t_{T}−θ], [Equation 6]

where ωₘ denotes an angular frequency of a base frequency band included in the reception signal from a tag, t_{RO} denotes a total delay time of the output signal D₃, ω_{C} denotes an oscillation angular frequency, and t_{T} denotes a response delay time in proportion to a distance between the tag and the RFID reader.

Thus, in comparison of Equations 5 and 6, a DC noise component as well as the phase noise component may be removed from the reception signal F₃ of the base frequency band. In Equation 6, since ω_{C}t_{T} and θ denote phases, ω_{C}t_{T} and θ do not act as phase noises.

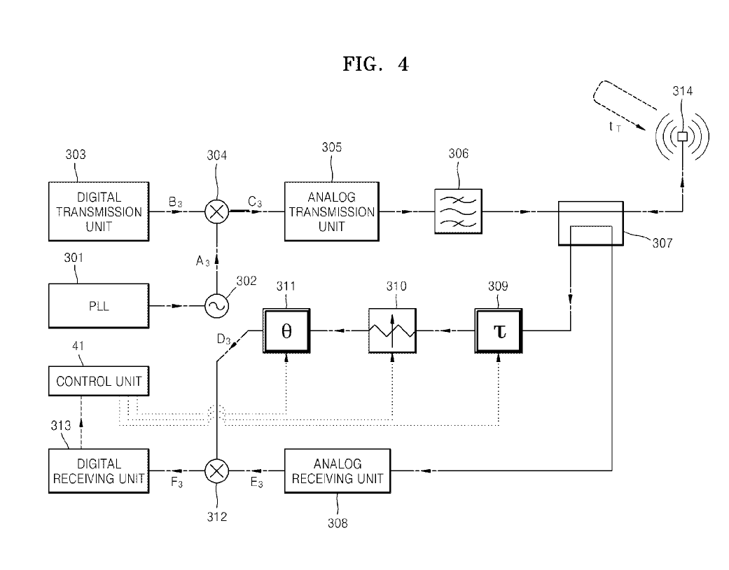

FIG. 4 is a block diagram of an RFID reader as a transceiver according to another exemplary embodiment.

Like reference numerals denote like elements between FIGS. 3 and 4. Thus, the differences between the RFID reader of FIG. 4 and the RFID reader described with reference to FIG. 3 will now be described.

Referring to FIGS. 3 and 4, the digital receiving unit 313 detects a noise component of the reception signal F₃ of the down mixer 312 and generates noise data.

A control unit 41 controls the attenuation unit 310, the phase adjusting unit 311, and the delay unit 309 according to the noise data generated by the digital receiving unit 313.

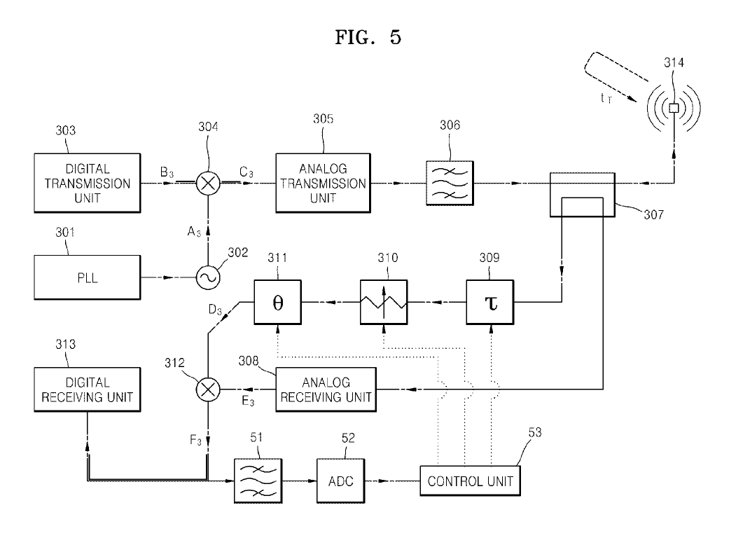

FIG. 5 is a block diagram of an RFID reader as a transceiver according to another exemplary embodiment.

Like reference numerals denote like elements between FIGS. 3 and 5. Thus, the differences between the RFID reader of FIG. 5 and the RFID reader described with reference to FIG. 3 will now be described.

Referring to FIGS. 3 and 5, the RFID reader as a transceiver of the present exemplary embodiment further includes a noise detection filter 51, an analog-digital conversion unit 52, and a control unit 53.

The noise detection filter 51 detects a noise component of the reception signal F₃ of the down mixer 312.

A low pass filter (LPF), a high pass filter (HPF), a band rejection filter (BRF), and a band pass filter (BPF), and the like may be used as the noise detection filter 51.

The analog-digital conversion unit 52 converts the noise component detected by the noise detection filter 51 into digital data and generates noise data.

The control unit 53 controls the attenuation unit 310, the phase adjusting unit 311, and the delay unit 309 according to the noise data generated by the analog-digital conversion unit 52.

As described above, according to the transceiver of the present exemplary embodiments, the spurious wave removing filter 306 causes a change of the phase noise component in the oscillation signal A₃ generated from the oscillation unit 301 and 302.

However, while the receiving portion 308, 312, and 313 convert the reception signal into the reception signal F₃ of the base frequency band, the output signal D₃ adjusted by the extraction signal adjusting portion 309 through 311 is combined with a reception signal E₃, and thus the phase noise component may be removed from the reception signal.

This is because the output signal D₃ adjusted by the extraction signal adjusting portion 309 through 311 is the transmission signal extracted from the signal division element 307, so that the phase noise component of the output signal D₃ overlaps that of the reception signal E₃.

However, when the transmission signal extracted from the signal division element 307 is merely used for down-conversion of a frequency, a DC noise occurs in the reception signal F₃ of the base frequency band. Such DC noise has a frequency band like the phase noise component, which influences a reception signal down-converted to a base frequency band.

Thus, the extraction signal adjusting portion 309 through 311 extracts the transmission signal of the signal division element 307, and adjusts a phase of the extracted signal, thereby preventing the phase noise from being influenced and the DC noise from occurring.

In conclusion, according to the transceiver of the present exemplary embodiment, a phase noise component may be effectively removed from a reception signal, thereby increasing a recognizable distance and improving the anti-collision performance.

While the exemplary embodiments have been particularly shown and described, it will be understood by one of ordinary skill in the art that various changes in form and details may be made therein without departing from the spirit and scope of the inventive concept as defined by the following claims. The exemplary embodiments should be considered in a descriptive sense only and not for purposes of limitation. Therefore, the scope of the inventive concept is defined not by the detailed description of the exemplary embodiments but by the following claims, and all differences within the scope will be construed as being included in inventive concept.

What is claimed is:

1. A transceiver, comprising:
an oscillation portion which generates an oscillation signal;
a transmission portion which converts a transmission signal of a base frequency band into a transmission signal of a radio frequency band by using the oscillation signal;
a spurious wave removing filter which removes a spurious wave of the transmission signal of the radio frequency band;
a transmission and reception antenna;
a signal division element which applies the transmission signal of the radio frequency band, which is processed by the spurious wave removing filter, to the transmission and reception antenna, and receives a reception signal of the radio frequency band from the transmission and reception antenna;
an extraction signal adjusting portion which extracts the transmission signal from the signal division element and adjusts a phase of the extracted signal to generate an output signal; and
a receiving portion which converts the reception signal received at the signal division element into a reception signal of the base frequency band by using the output signal from the extraction signal adjusting portion.

2. The transceiver of claim 1, wherein the extraction signal adjusting portion comprises:
an attenuation unit which reduces an amplitude of the extracted signal; and
a phase adjusting unit which adjusts the phase of the extracted signal of which the amplitude is reduced by the attenuation portion to generate the output signal from the extraction signal adjusting portion.

3. The transceiver of claim 2, wherein the extraction signal adjusting portion further comprises a delay unit which delays the extracted signal by a set period of time and inputs the delayed signal, which is delayed by the set period of time, into the attenuation portion for reducing the amplitude thereof.

4. The transceiver of claim 3, wherein the receiving portion comprises:
an analog receiving unit which processes the reception signal received by the signal division element to amplify the reception signal and remove a harmonic wave component from the amplified signal;
a down mixer which converts the reception signal processed by the analog receiving unit into the reception signal of the base frequency band by using the output signal of the phase adjusting unit; and
a digital receiving unit which converts the reception signal converted by the down mixer into a digital signal and decodes the digital signal.

5. The transceiver of claim 4, wherein the digital receiving unit detects a noise component of the reception signal converted by the down mixer and generates noise data.

6. The transceiver of claim 5, further comprising; a control unit which controls the attenuation unit, the phase adjusting unit, and the delay unit according to the noise data generated by the digital receiving unit.

7. The transceiver of claim 4, further comprising:
a noise detection filter which detects a noise component of the reception signal converted by the down mixer;
an analog-digital conversion unit which converts the noise component detected by the noise detection filter into digital data and generates noise data; and
a control portion which controls the attenuation unit, the phase adjusting unit, and the delay unit according to the noise data generated by the analog-digital conversion unit.

8. The transceiver of claim 1, wherein the oscillation portion comprises:
a signal generation unit which generates the oscillation signal of a set frequency; and
a phase locked loop (PLL) circuit which is connected to the signal generation unit and fixes the set frequency of the oscillation signal.

9. The transceiver of claim 1, wherein the transmission portion comprises:
a digital transmission unit which encodes transmission data, converts the encoded transmission data into an analog signal, and generates the transmission signal of the base frequency band;
an up mixer which converts the transmission signal of the base frequency band into the transmission signal of the radio frequency band by using the oscillation signal generated by the oscillation portion; and
an analog transmission unit which amplifies the transmission signal converted by the up mixer and inputs the amplified transmission signal into the spurious wave removing filter.

10. A radio frequency identification (RFID) transceiver, comprising:
a transmission portion which generates a transmission signal;
an antenna which transmits the transmission signal and receives a reception signal;
a signal division element which receives the transmission signal from the transmission portion and inputs the received transmission signal to the antenna for transmission, and receives the reception signal received by the antenna;
an extraction signal adjusting portion which extracts the transmission signal from the signal division element, and adjusts a phase of the extracted signal to generate an output signal; and
a receiving portion which receives the reception signal from the signal division element, and applies the output signal from the extraction signal adjusting portion to the reception signal.

11. The RFID transceiver of claim 10, wherein the extraction signal adjusting portion delays the extracted signal by a set period of time.

12. The RFID transceiver of claim 10, wherein the extraction signal adjusting portion reduces an amplitude of the extracted signal.
